(19) United States
(12) Patent Application Publication
(10) Pub. No.: US 2025/0260007 A1
(43) Pub. Date: Aug. 14, 2025

(54) HIGH POWER CATHODE FOR USE IN ELECTROCHEMICAL CELLS

(71) Applicant: Crimen Tech Private Limited, Thiruvananthapuram (IN)

(72) Inventors: Hari Krishnan D, Trivandrum (IN); Meghna S Nair, Pleasanton, CA (US); Bharat S I, Trivandrum (KL); Gokul G S, Trivandrum (IN)

(73) Assignee: Crimen Tech Private Limited, Thiruvananthapuram, KL (IN)

(21) Appl. No.: 19/040,073

(22) Filed: Jan. 29, 2025

(30) Foreign Application Priority Data
Jan. 18, 2025 (IN) 202541004195

(51) Int. Cl. H01M 4/525; H01M 4/02; H01M 4/04; H01M 4/1391; H01M 4/36; H01M 4/62; H01M 4/66; H01M 4/70; H01M 10/0525

(52) U.S. Cl. CPC H01M 4/525; H01M 4/0404; H01M 4/0435; H01M 4/1391; H01M 4/364; H01M 4/622; H01M 4/625; H01M 4/661; H01M 4/70; H01M 10/0525; H01M 2004/021; H01M 2004/028

(57) ABSTRACT

The present invention provides a cathode for electrochemical cells, comprising a combination of electroactive materials and additive active materials in a weight ratio of 85-95%, binders in a range of 3-8% by weight, and conductive diluents in a range of 1-5% by weight. The electroactive materials include lithium manganese iron phosphate (LLMFP), lithium ferro phosphate (LFP), nickel-manganese-cobalt oxides (NMC 111, NMC 532, NMC 622, NMC 811, NMC 9 0.5 0.5), and lithium nickel cobalt aluminum oxide (NCA). The additive active materials include lithium cobalt oxide (LCO), lithium nickel cobalt aluminum oxide (NCA), and lithium-ion manganese oxide (LMO). The disclosed cathode enables formation of a high power density electrochemical cell, while maintaining optimal energy density, an extended lifecycle having a high number of charge-discharge cycles.

### PRIORITY STATEMENT

The present application claims priority under 35 U.S.C. § 119 to Indian patent application number 202541004195 filed Jan. 18, 2025, the entire contents of which are hereby incorporated herein by reference.

### FIELD

The present disclosure relates generally to the manufacturing of electrodes used in electrochemical cells. More particularly the present disclosure relates to manufacturing high power cathodes for lithium-ion batteries.

### BACKGROUND

The demand for high-performance lithium-ion batteries has grown significantly, driven by their applications in power-demanding, space-constrained devices such as drones, medical devices, portable electronics, and electric vehicles. A key concept in these applications is “compact power,” which refers to a battery's ability to deliver high power output while maintaining a small physical size and low weight. Achieving compact power is challenging as it requires sustaining high currents without significant voltage drops or overheating, which can compromise the device's performance and reliability. For applications requiring continuous discharge rates exceeding 10 C, the battery must not only support high currents but also ensure efficient thermal management and minimal loss in efficiency. Balancing energy density, power output, and durability is essential to meeting the demands of these high-performance applications.

A major challenge in achieving high power output is optimizing the cathode structure for efficient ionic and electronic transport. Conventional methods for manufacturing high-power cathodes often focus on improving the electrode composition and structure to support high discharge rates. For instance, reducing the loading level of the cathode decreases its overall thickness, which facilitates faster lithium-ion diffusion. Another common approach is compacting the electrode after coating, ensuring uniform particle distribution and a denser, more conductive network. This compaction process enhances electrolyte penetration, allowing better access to the deep regions of the electrode. While these techniques reduce ionic and electronic resistance, enabling the cathode to handle high current densities, they often come at the expense of energy density and cycle life.

Despite the progress in optimizing cathode design, balancing power density and energy density remains a key challenge. The performance of a lithium-ion cell is influenced by the capacity of the active materials, the conductivity of conductive additives, and the volume and density of the slurry constituents. Industry methods typically employ active materials capable of high discharge rates, such as low-nickel composites. However, the ratios of constituents such as manganese, cobalt, aluminium, and nickel directly affect the ability of these materials to deliver high discharge rates. Using low-nickel, high-manganese, cobalt, or aluminium oxides can improve discharge rates but often sacrifices energy density, cycle life, and voltage stability. Hence, achieving an optimal trade-off between energy density and power density is critical. For example, cathodes made with materials like Lithium Iron Phosphate (LFP) or NMC 532 exhibit excellent discharge rates but may not offer the energy density needed for long runtimes in power-demanding applications.

Thus, designing high-performance cathodes requires the careful selection of materials, including the type and thickness of foils and separators, and the composition of active materials. Despite advancements, issues like capacity degradation, reduced cycle life, and voltage instability remain prevalent, particularly when designing high-power cathodes intended for applications that require both high energy and power output simultaneously.

Hence, an alternative high power cathode is required that overcomes the challenges identified in the prior art and provides both high power density and high energy density while minimizing resistance in the electrochemical cell.

### OBJECT OF THE INVENTION

The primary objective of the present invention is to provide a high power cathode for lithium-ion batteries that simultaneously delivers high power density and high energy density, while minimizing resistance, ensuring efficient ion and electron transport, and maintaining optimal cycle life and voltage stability. This invention seeks to overcome the limitations of existing high power cathodes that typically suffer from trade-offs between power and energy performance, resulting in compromised discharge rates or reduced cycle life.

Another objective is to develop a method for producing a cathode that uses a carefully selected combination of electroactive materials, such as nickel-manganese-cobalt oxide (NMC) 532 and Lithium Cobalt Oxide (LCO), to optimize both power and energy output without sacrificing performance or longevity. The invention aims to provide a balanced solution for high-power applications requiring both rapid discharge capabilities and extended runtime, addressing the needs of space-constrained, power-demanding devices like drones, medical devices, and electric vehicles.

A further objective is to enhance the manufacturability of the cathode by introducing an improved slurry formulation and coating process that ensures uniform particle distribution, increased electrode density, and efficient electrolyte penetration, ultimately leading to superior battery performance.

An additional object of the invention is to provide an electrode fabrication method that allows for uniform coating on conductive foils, ensuring optimal porosity, consistent thickness, and reliable performance in high-power applications such as electric vehicles, air mobility systems, and power tools.

By achieving these objectives, the invention aims to address the dual challenges of maximizing energy storage and optimizing power delivery for next-generation electrochemical cells.

### SUMMARY

The following summary is illustrative only and is not intended to be in any way limiting. In addition to the illustrative aspects, example embodiments, and features described, further aspects, example embodiments, and features, will become apparent by reference to the drawings and the following detailed description.

The invention relates to a cathode for use in electrochemical cells, particularly lithium-ion batteries, which comprises a unique composition designed to enhance electrochemical performance. The cathode of the electrochemical device comprises a composition coated on a current collector, the composition comprises 85-95% by weight of a combination of the electroactive material and an additive active material, 3-8% by weight of one or more biners, and 1-5% by weight of one or more conductive diluents. In an embodiment, the current collector is made of aluminium and has a thickness ranging from 10 to 19 micron.

In an embodiment, the combination is a viscous slurry having viscosity of 3000-6000 millipascal-second (mPa·s). Further, a solid content of the viscous slurry is in a range of 45-55%, and a loading level of the combination is 15-35 mg/cm3. When the slurry is coated on the current collector, a thickness of the coat on the current collector ranges from 130 to 160 microns. The coat is then subjected to drying at a gradient temperature ranging from 40 to 120 degree Celsius. Upon drying, the coat is subjected to calendaring at a controlled pressure to reduce a thickness of the coat to 110 to 125 microns.

The electroactive material is selected from one or more of lithium manganese iron phosphate (LLMFP), lithium ferro phosphate (LFP), nickel-manganese-cobalt oxide (NMC) variants such as NMC 111, NMC 532, NMC 622, NMC 811, NMC 9 0.5 0.5, and lithium nickel cobalt aluminium oxide (NCA). Typically, the electroactive material in the cathode provides the primary source of lithium-ion transport during charge and discharge cycles. The aforementioned electroactive materials offer further advantages as mentioned hereinbelow:
1. Lithium manganese iron phosphate (LLMFP) offers enhanced thermal stability and long cycle life, suitable for applications requiring safety and longevity.
2. Lithium ferro phosphate (LFP) is known for its high structural stability, excellent thermal performance, and prolonged cycle life.
3. Nickel-manganese-cobalt oxide (NMC) includes variants such as NMC 111, that provides balanced energy density and stability, and NMC 532, 622, 811, and 9 0.5 0.5, variants progressively increase nickel content to enhance energy density while reducing cobalt dependency for cost-effectiveness and sustainability.
4. Lithium nickel cobalt aluminium oxide (NCA) delivers high energy density and specific capacity, ideal for high-performance applications.

Further the additive active material is incorporated to complement the electroactive material, for improving the overall cathode performance. The additive active material is selected from one or more of lithium cobalt oxide (LCO), lithium nickel cobalt aluminium oxide (NCA), and lithium ion manganese oxide (LMO). The aforementioned additive active materials offer further advantages as mentioned hereinbelow:
1. Lithium cobalt oxide (LCO) provides high volumetric energy density and stable operation;
2. Lithium nickel cobalt aluminium oxide (NCA) enhances energy output while contributing to cycle stability; and
3. Lithium ion manganese oxide (LMO) offers high power capability and good thermal stability.

In one embodiment, the composition of the cathode comprises a blend of electroactive material and additive active material, where 80% to 90% of the total weight is electroactive material, and the remaining 10% to 20% is composed of the additive active material. In a more specific embodiment, the electroactive material is nickel-manganese-cobalt oxide (NMC) 532, and the additive active material is lithium cobalt oxide (LCO). The total combined weight of NMC 532 and LCO within the composition of the cathode lies between 85% and 95%. The weight ratio of NMC 532 to LCO within the composition (cathode coating) ranges from 80% to 90% for NMC 532 and 10% to 20% for LCO.

Further, a particle size of NMC 532 is in a range of 4.0-8.0 micrometer, and a density of NMC 532 is in a range of 3.4-3.8 g/cm3. Similarly, a particle size of LCO is in a range of 10-15 micrometer, and a density of LCO is in a range of 2.4-2.8 g/cm3.

This carefully combination of materials serves to improve both the energy density and cycle life of the electrochemical cell. NMC 532, a high-capacity material known for its stability and high energy density, is enhanced by the inclusion of LCO, which helps improve the overall charge retention and efficiency of the cell. The result is a cathode structure that significantly enhances the performance of the electrochemical cell, making it ideal for applications requiring high capacity, extended cycle life, and reliable performance over long-term use.

Additionally, the one or more binders (in the range of 3-8% by weight) provide structural stability and cohesion to the cathode. The one or more binders is selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate, and wherein the one or more binders is dissolved in a N-Methyl-2-pyrrolidone (NMP) solvent at a concentration of 45 to 55% by weight to create a uniform binder solution.

The conductive diluents are selected from single-walled carbon nanotubes (SWCNT), Super P, multi-walled carbon nanotubes (MWCNT), graphene, carbon nanofibers (CNFs), activated carbon, conducting carbon, porous carbon, and ketjen black. The weight proportion of 1-5% of the one or more conductive diluents improve the electrical conductivity of the cathode. The composition of the cathode as disclosed herein is designed to enhance an overall performance of electrochemical cells, making it suitable for use in a wide variety of applications, including electric vehicles, portable electronic devices, and energy storage systems.

The power density of the electrochemical cell comprising the cathode, can go up to 5000 W/kg and the specific energy density can be up to 205 Wh/kg. Further, a capacity of the electrochemical cell ranges from 3 Ah to 5 Ah. The electrochemical cell comprising the cathode exhibits a discharge rate of at least 25 C for pulse power, and a discharge rate of at least 11 C for continuous power, while the cathode facilitates continuous discharge at a current of at least 45 Amperes. The cathode, exhibits an extended lifecycle of up to 300 charge-discharge cycles at a continuous discharge rate of 11 C and a pulse discharge rate of 25 C. The electrochemical cell formed by disclosed cathode shows a low internal resistance of 2.5 milliohms. The low internal resistance facilitates a discharge of up to 96.25% of a capacity of the electrochemical cell capacity at a discharge rate of 11 C, when the electrochemical cell is discharged within an operational voltage range.

According to an embodiment, the invention discloses a method for manufacturing a high power cathode for an electrochemical cell. The process begins with the preparation of a cathode slurry comprising 92-94% by weight of a combination of an electroactive material and an additive active material; where the electroactive material is selected from one or more of lithium manganese iron phosphate (LLMFP), lithium ferro phosphate (LFP), nickel-manganese-cobalt oxide (NMC) 111, NMC 532, NMC 622, NMC 811, NMC 9 0.5 0.5, Lithium Nickel Cobalt Aluminum Oxide (NCA), and the additive active material is selected from one or more of Lithium Cobalt Oxide (LCO), Lithium Nickel Cobalt Aluminum Oxide (NCA), and Lithium ion manganese oxide (LMO),

In an example, the electroactive material includes 80 to 90% of nickel-manganese-cobalt oxide (NMC) 532 and the additive active material includes 20 to 10% of Lithium Cobalt Oxide (LCO). The combination of NMC 532 and LCO in a ratio of 9:1 as mentioned above, enhances the energy density and cycle life of the cathode. The cathode slurry also contains 1-5% by weight of one or more conductive diluents, selected from single-walled carbon nanotubes (SWCNT), Super P, multi-walled carbon nanotubes (MWCNT), graphene, carbon nanofibers (CNFs), activated carbon, conducting carbon, porous carbon, and ketjen black, to improve electrical conductivity. Furthermore, 3-8% of a binder composition is included in the cathode slurry, which may consist of Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA), and 5130 solvate, providing structural cohesion and integrity to the cathode. In an embodiment, the one or more binders are dissolved in a N-Methyl-2-pyrrolidone (NMP) solvent at a concentration of 45 to 55% by weight to form a uniform binder solution.

Once the slurry is prepared, it is coated onto a current collector to form a layer with a pre-calendaring thickness of 130-160 microns. The coated layer is then dried at one or more temperatures ranging from 40 to 120° C. to remove solvents and moisture, ensuring optimal adhesion and electrochemical properties. In an embodiment, a solid content of the cathode slurry is adjusted to 45 to 55% by weight. Further, a viscosity of the cathode slurry is adjusted in a range of 3000 to 6000 mPa·s, prior to coating the slurry onto the current collector.

Finally, the cathode undergoes a calendaring process, where it is compressed to achieve a final thickness of 110-125 microns, improving the electrode's density and conductivity. A loading level of the coated layer, which refers to the amount of electroactive material deposited on the current collector before calendaring, is maintained within a range of 15 to 35 mg/cm². The calendaring of the cathode facilitates a port density of 30 to 75%. This method results in a high-performance cathode suitable for use in various electrochemical cells, including lithium-ion batteries used in electric vehicles and energy storage systems.

According to another embodiment, an electrochemical device or an electrochemical cell is disclosed that includes several key components designed for efficient energy storage and discharge. The electrochemical cell features a cathode, which comprises of a combination of an electroactive material comprising a combination of NMC 532 (nickel-manganese-cobalt oxide) and LCO (lithium cobalt oxide) in a weight proportion ranging from 85-95%. The combination further includes binders (in the range of 3-8% by weight) and conductive diluents, in the range of 1-5% by weight.

This combination is formed into a slurry and is coated and dried onto a positive current collector. In a further aspect, the positive current collector is made of aluminum, with a thickness ranging from 10 to 18 microns, providing the necessary structural support while maintaining good conductivity for efficient energy flow in the electrochemical cell. The positive current collector is in electric connection with an external circuit to facilitate charge and discharge cycles. A thickness of the slurry coated on the positive current collector ranges from 130 to 160 microns, and wherein upon drying the slurry, the coated cathode is calendared to achieve a final thickness of 110 to 125 microns.

The electrochemical cell also includes an anode that is in electronic contact with a negative current collector, which is similarly connected to the external circuit. A separator is positioned between the positive and negative electrodes to maintain physical separation while allowing ionic conduction. The electrochemical cell is further equipped with an electrolyte, which is in ionic contact with both the positive and negative electrodes, ensuring efficient ion transport during battery operation.

The disclosed electrochemical cell demonstrates exceptional suitability for applications in energy storage systems, electric vehicles, and other devices demanding high performance, long cycle life, and reliable operation under varying loads. With an internal resistance of just 2.5 milliohms, the cell achieves a high closed-circuit voltage of 3.8 volts (V) when the open-circuit voltage is 4.2 V, indicating minimal energy loss during operation. This low internal resistance ensures efficient energy delivery, reduced heat generation, and improved safety, particularly during high-rate discharge scenarios.

A key technical advantage of the electrochemical cell lies in its stable voltage profile during discharge. In one embodiment, the voltage decreases gradually from 3.8 V to 2.5 V under a continuous discharge rate of 11 C, ensuring consistent power output and mitigating abrupt performance drops. At this discharge rate, the cell delivers a substantial capacity of 3.85 ampere-hours (Ah) out of a total capacity of 4.0 Ah, achieving up to 96.25% utilization of its available capacity within the operational voltage range of 3.8 V to 2.5 V.

Use of a cathode composition combining nickel-manganese-cobalt oxide (NMC 532) as the electroactive material and lithium cobalt oxide (LCO) as the additive material enhances both energy density and cycle life. This tailored combination not only optimizes energy storage capabilities but also ensures superior performance under high-load conditions, such as those encountered in electric vehicle acceleration or rapid charge-discharge cycles in energy storage systems.

Additional advantages include excellent thermal stability, enabling safe operation under varying environmental conditions, and robust cycle stability, with the cell capable of sustaining hundreds of charge-discharge cycles without significant capacity degradation. The gradual voltage decrease characteristic of this design further contributes to predictable and stable performance, making the cell particularly suitable for high-capacity, high-power applications where reliability and efficiency are critical.

These and other embodiments of the present disclosure are discussed in further detail hereinbelow.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates a perspective view of a high power cathode, according to an example embodiment;

FIG. 2 illustrates a schematic view of an electrochemical cell including a high power cathode, according to an example embodiment;

FIG. 3 illustrates a process flow of manufacturing a high power cathode, according to an example embodiment;

FIG. 4 is flowchart illustrating a method of manufacturing a high power cathode, according to an example embodiment;

FIG. 5 is a graph showing voltage as a function of capacity of the cathode during continuous discharge, according to an example embodiment; and

FIG. 6 is a graph illustrating a pulse discharge of current and voltage of an electrochemical cell embodying a high power cathode, according to an example embodiment.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, elements, and/or components, but do not preclude the presence or addition of one or more other features, integers, steps, operations, elements, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below.

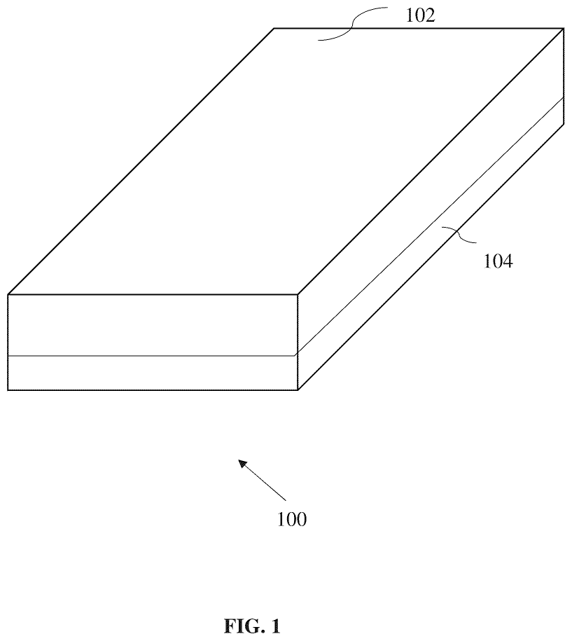

FIG. 1 illustrates a perspective view of a high power cathode 100, according to an example embodiment. As shown, the cathode 100 includes a composition 102 coated on a current collector 102. Typically, the composition 102 includes 85-95% by weight of a combination of an electroactive material and an additive active material; 3-8% by weight of one or more binders; and 1-5% by weight of one or more conductive diluents selected from single-walled carbon nanotubes (SWCNT), Super P, multi-walled carbon nanotubes (MWCNT), graphene, carbon nanofibers (CNFs), activated carbon, conducting carbon, porous carbon, and ketjen black.

The electroactive material comprises one or more of lithium manganese iron phosphate (LLMFP), lithium ferro phosphate (LFP), nickel-manganese-cobalt oxide (NMC) 111, NMC 532, NMC 622, NMC 811, NMC 9 0.5 0.5, Lithium Nickel Cobalt Aluminum Oxide (NCA). The additive active material comprises one or more of Lithium Cobalt Oxide (LCO), Lithium Nickel Cobalt Aluminum Oxide (NCA), and Lithium ion manganese oxide (LMO).

In an embodiment, the electroactive material is nickel-manganese-cobalt oxide (NMC) 532 and the additive active material is Lithium Cobalt Oxide (LCO). Further, the combination comprises 80 to 90% by weight of nickel-manganese-cobalt oxide (NMC) 532 and 20 to 10% by weight of Lithium Cobalt Oxide (LCO). Typically, the cathode comprises NMC 532 and LCO in a range of 85-95% by weight, one or more binders in a range of 3 to 8% by weight, and one or more conductive diluents in a range of 1 to 5% by weight.

The electroactive layer in the battery is carefully designed using a blend of NMC 532 (Nickel-Manganese-Cobalt oxide) and LCO (Lithium Cobalt Oxide) to achieve an optimal balance between energy density and power density. Each material plays a distinct role in enhancing the battery's overall performance and making it suitable for a variety of applications.

NMC 532 constitutes 80-90% of the electroactive layer, serving as the dominant component. Its primary function is to enhance the battery's energy density, allowing it to store more energy and provide a longer runtime per charge. This makes NMC 532 particularly well-suited for applications such as electric vehicles (EVs) and stationary energy storage systems, where prolonged operation is essential. Furthermore, NMC is known for its versatility, offering good cycling performance and thermal stability, which ensures reliability in energy-intensive applications. Typically, a particle size of NMC 532 is in a range of 4.0-8.0 micrometer, and a density of NMC 532 is in a range of 3.4-3.8g/cm3.

On the other hand, LCO makes up the remaining 10-20% of the electroactive layer. Its inclusion is crucial for improving the power density of the battery, enabling it to deliver energy rapidly and handle high discharge rates. This characteristic makes LCO highly effective in scenarios requiring instantaneous power delivery, such as in high-performance consumer electronics or systems that experience sudden load demands. By incorporating LCO, the battery is equipped to efficiently manage peak power requirements while maintaining consistent performance. A particle size of LCO is in a range of 10-15 micrometer, and a density of LCO is in a range of 2.4-2.8 g/cm3.

The combination of NMC 532 and LCO in these specific proportions creates a synergistic balance between energy storage capacity and rapid energy delivery. While NMC focuses on providing sustained energy for long-term use, LCO ensures the battery can handle bursts of power when needed. This balanced design makes the battery versatile enough to meet both extended energy demands and immediate power needs, enabling its use in a wide range of applications, from portable electronics to automotive and industrial systems.

The one or more binders selected for the electroactive material include one or more of Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate. The one or more binders are dissolved in a N-Methyl-2-pyrrolidone (NMP) solvent at a concentration of 45 to 55% by weight to create a uniform binder solution.

Further, the one or more conductive diluents are selected from SWCNT (single walled carbon nanotubes), Super P, Multi-Walled Carbon Nanotubes (MWCNT), graphene, carbon nanofibers (CNFs), activated carbon, conducting carbon, porous carbon, and ketjen black in a range of 1 to 5% by weight.

The electroactive material combination is converted into a slurry by mixing it with water and the solvent (NMC), to form a cathode slurry. The cathode slurry is then coated onto the current collector 104 and is then dried to form the electrode 100. A solid content of the cathode slurry is maintained within a range of 45-55%. The solvent facilitates homogeneity in the cathode slurry, while water helps control the cathode slurry's viscosity and wetting properties. The cathode slurry is prepared to achieve a viscosity in the range of 3000-6000 millipascal-seconds (mPa·s), a critical parameter for ensuring uniform coating and optimal adhesion to the current collector.

The slurry is carefully coated onto the current collector 104, typically made of aluminum foil, using a precision coating technique such as doctor blade coating or slot-die coating. These methods help maintain a consistent thickness across the electrode, ensuring uniform electrochemical performance. Typically, a thickness of the composition 102 that is coated lies in a range of 130 to 150 microns.

The coated layer is then subjected to a controlled drying process in a convection or vacuum oven to remove the solvent and water content, resulting in a solid and uniform cathode layer. During this drying phase, the slurry's composition transitions to form a cohesive structure, with the binder material providing mechanical integrity to the electrode.

The solid content of the cathode slurry is maintained within a range of 45-55%, which is critical for balancing coating consistency, drying efficiency, and the resulting electrode's electrochemical performance. A higher solid content improves electrode density and capacity but can increase slurry viscosity, complicating the coating process. Conversely, a lower solid content may lead to poor energy density and weaker adhesion to the current collector.

Post-drying, the cathode layer is subjected to calendaring to compress the coated composition 102, enhancing electrode density and reducing internal resistance. During calendaring a pressure ranging from 25-60 MPascal is applied by use of rollers to compress and coat onto the foil. The pressure exerted is such that the porosity and size of pores is maintained to ensure good electric conductivity. A final thickness of the composition 102 post calendaring lies in a range of 110 to 125 microns. In another embodiment, a thickness of the composition 102 post calendaring lies in a range of 112 to 120 microns. The cathode 100, post calendaring exhibits optimized porosity and mechanical strength, which are essential for ensuring high energy density, cycle life, and efficient ion transport during battery operation.

The aforementioned process ensures that the cathode 100 maintains the desired electrochemical properties, supporting a balance of energy density and power density as dictated by the NMC 532 and LCO material proportions.

Typically, a capacity of the cathode 100 achieved ranges from 3 Ampere hour (Ah) to 5 Ah. A specific energy density of the cathode 100 exhibited is at least 200 Watt hour (Wh)/Kilogram (kg). A power density achieved for the cathode 100, is at least 5000 W/Kg. Further, a discharge rate exhibited by the cathode 100 is at least 25 C for pulse power, and at least 11 C for continuous power, where the electrode continuously discharges at least at 45 Amperes of current.

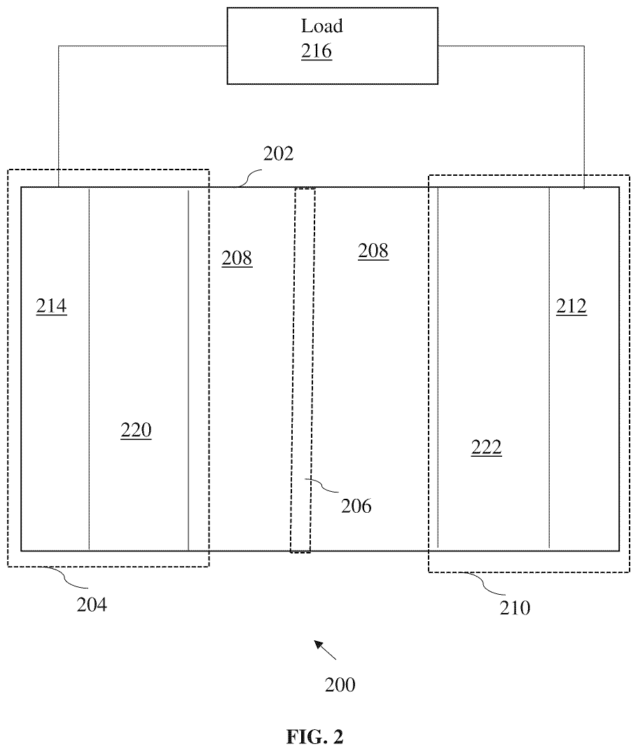

FIG. 2 illustrates a schematic view 200 of an electrochemical cell 202 including a high power cathode 204, an anode 210, a separator 206, and an electrolyte 208. The electrochemical cell 202 is connected to a load 216 via an external electrical circuit 218. As shown, the high power cathode 204, includes a current collector 216 that is coated with a composition 220.

The composition 220 includes 85-95% by weight of a combination of an electroactive material and an additive active material; 3 to 8% by weight of one or more binders; and 1 to 5% by weight of one or more conductive diluents selected from SWCNT (single walled carbon nanotubes), Super P, Multi-Walled Carbon Nanotubes (MWCNT), graphene, carbon nanofibers (CNFs), activated carbon, conducting carbon, porous carbon, and ketjen black.

The electroactive material comprises one or more of lithium manganese iron phosphate (LLMFP), lithium ferro phosphate (LFP), nickel-manganese-cobalt oxide (NMC) 111, NMC 532, NMC 622, NMC 811, NMC 9 0.5 0.5, Lithium Nickel Cobalt Aluminum Oxide (NCA), and wherein the additive active material comprises one or more of Lithium Cobalt Oxide (LCO), Lithium Nickel Cobalt Aluminum Oxide (NCA), and Lithium ion manganese oxide (LMO). In an example, the combination comprises 80 to 90% by weight of nickel-manganese-cobalt oxide (NMC) 532 and 20 to 10% by weight of Lithium Cobalt Oxide (LCO). A particle size of NMC 532 is maintained in a range of 4.0-8.0 micrometer, and a density of NMC 532 is maintained in a range of 3.4-3.8 g/cm3. Further, a particle size of LCO is in a range of 10-15 micrometer, and a density of LCO is in a range of 2.4-2.8 g/cm³.

Further, the one or more binders are selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate. In an embodiment, the one or more binders are dissolved in a N-Methyl-2-pyrrolidone (NMP) solvent at a concentration of 45 to 55% by weight to create a uniform binder solution.

Similarly, the anode 210 includes a current collector 212 (e.g. a copper foil) and is coated with a composition layer 222. In an embodiment, the composition layer 222 can include a combination of an electroactive material comprising a combination of silicon oxide with a structure of SiOₓ 0.1≤x≤ 2.0 and graphite in a range of 90-95% by weight, one or more binders in a range of 4-6% by weight, and one or more conductive diluents including SWCNT (single walled carbon nanotubes), Super P, Super C65, and Poly Acrylic Acid (PAA) in a range of 2 to 4% by weight, in 40-50% of water.

The current collector 216 and the current collector 212 are further connected to the load 216 via the external electrical circuit 218. Furthermore, the electrochemical cell 202 includes a separator 206 positioned between the cathode 204 and the anode 210. In an embodiment, the separator can be a ceramic coated separator. An electrolyte 208 in ionic contact with the cathode 204 and the anode 210 is provided in a space between the cathode 204 and the anode 210. In an embodiment, the cathode 204, the anode 210, and the separator 210 comprise a sintered subassembly. The current collector 214 can be made of aluminum, and the current collector 210 can be a copper plate or foil. Current flows between the current collector 214 via a load 216 to the current collector 212.

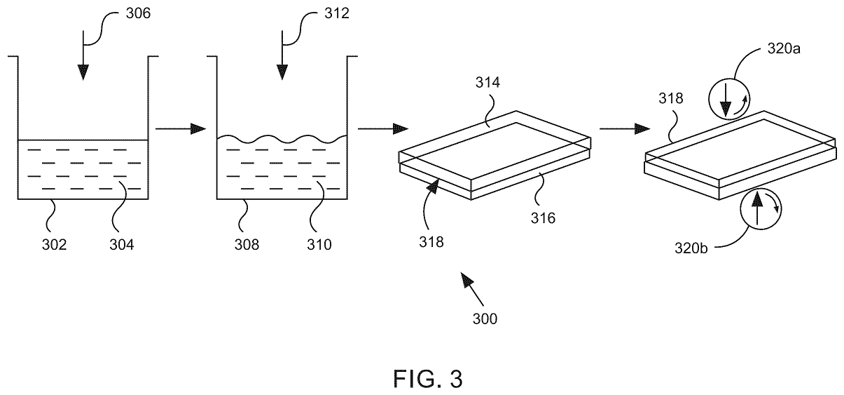

FIG. 3 illustrates a process flow 300 of manufacturing a high power cathode, according to an example embodiment. As shown, a combination 306 of 92-94% by weight of a combination of an electroactive material and an additive active material; 1 to 5% by weight of one or more conductive diluents and 3 to 8% by weight of a binder composition comprising one or more binders, are mixed in a mixer jar 302 to form an admixture 306.

Example, of the electroactive material include one or more of lithium manganese iron phosphate (LLMFP), lithium ferro phosphate (LFP), nickel-manganese-cobalt oxide (NMC) 111, NMC 532, NMC 622, NMC 811, NMC 9 0.5 0.5, Lithium Nickel Cobalt Aluminum Oxide (NCA). Examples of the additive active material include one or more of Lithium Cobalt Oxide (LCO), Lithium Nickel Cobalt Aluminum Oxide (NCA), and Lithium ion manganese oxide (LMO). In an embodiment, the combination comprises 80 to 90% by weight of nickel-manganese-cobalt oxide (NMC) 532 and 20 to 10% by weight of Lithium Cobalt Oxide (LCO). Example of the one or more conductive diluents include SWCNT (single walled carbon nanotubes), Super P, Multi-Walled Carbon Nanotubes (MWCNT), graphene, carbon nanofibers (CNFs), activated carbon, conducting carbon, porous carbon, and ketjen black. The one or more binders are selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate.

The admixture 304 is then mixed with a solvent 312 in a tank 308 to form a cathode slurry 310. In an embodiment, the solvent 312 is N-Methyl-2-pyrrolidone (NMP) at a concentration of 45 to 55% by weight. The solvent 312 mixes with the one or more binders in the admixture 304 to form a uniform binder solution. Further, the solvent 312 is mixed such that a solid content of the cathode slurry is adjusted to 45 to 55%, and a viscosity of the cathode slurry 310 is maintained at 3000 to 6000 mPa. The viscosity and the solid content of cathode slurry 310 is adjusted within the tank 308, prior to coating the cathode slurry onto a current collector 316.

The cathode slurry 310 is then coated on the current collector 316 to form a cathode 318 that has a layer of coat 314 on the current collector 316. In an embodiment, the current collector 316 is a conductive foil made of aluminum. In an embodiment, a thickness of the current collector 316 is selected in a range of 10 to 12 microns, and a thickness of the coat 314 is 140 to 150 microns.

In the method of manufacturing the cathode for the electrochemical cell, the loading level of the cathode material plays a crucial role in determining the efficiency and performance of the resulting electrochemical cell. Specifically, the loading level prior to calendaring is maintained within the range of 15 to 35 mg/cm², which refers to the mass of electroactive material-combining NMC 532 and LCO-that is applied to the positive current collector during the coating process.

Maintaining this optimal loading level is critical for several reasons. First, it ensures that the cathode material is neither too thin nor too thick, allowing for an ideal balance between energy density and ion transport efficiency. If the coating is too thin, the energy storage capacity will be insufficient, while a coating that is too thick can cause inefficiencies, such as higher internal resistance and poor ion diffusion. A loading level of 20-22 mg/cm² helps optimize the overall energy density of the electrochemical cell, enabling it to store more energy while maintaining high performance.

Additionally, this loading level ensures the formation of a uniform coating on the current collector. Uniformity is essential for consistent electrochemical performance; uneven distribution of the active material can result in hotspots, which might hinder ion transport and reduce overall cell efficiency. On the other hand, a coat that is too thin may not provide enough active material for sufficient energy storage, leading to limitations in performance and efficiency.

Once the slurry is coated onto the current collector, it undergoes the calendaring process, which compresses the cathode layer to a final thickness. A loading level of the coat is maintained at 15 to 35 mg/cm³ to ensure that after calendaring, the cathode achieves an ideal electrode density. This density is crucial for maximizing the electrochemical reaction rate, as it minimizes internal resistance and enhances the charge-discharge efficiency of the battery. The loading level thus directly impacts the final porosity and compactness of the cathode material, which influences ion diffusion rates and overall electrochemical performance.

Moreover, an optimized loading level contributes to the cycle life and stability of the battery. When the loading is properly controlled, the active material is present in the correct amount, helping to maintain stable cycling behavior over time. Excessive loading could lead to cracking or delamination of the cathode material during charge and discharge cycles, negatively affecting both the cycle life and structural integrity of the electrode.

The specified loading range also plays a role in manufacturing efficiency. It ensures that the slurry is applied uniformly across the collector, reducing material waste and improving the overall yield in the production process. This balance between material application and performance contributes to a cost-effective manufacturing method, which allows high-volume production of electrochemical cells without compromising performance.

Overall, maintaining the loading level within the range of 15 to 35 mg/cm² prior to calendaring ensures an optimized balance between energy density, power output, cycle life, and manufacturing efficiency, contributing to the high performance of the electrochemical cell in applications such as electric vehicles, energy storage systems, and portable electronics.

The cathode 318 is then calendared in a calendaring machine having at least two precision rollers 320a-320b. The pressure applied on the layer of coat 314, helps bind the active material with the binders, reduce a pore size and increase the porosity of the cathode 318 to enhance electrical conductivity. In an example, a pressure ranging from 50-60 MPascal is applied on the layer of coat 314 to achieve a coating thickness of 112 to 120 microns, and a pore density of 35%.

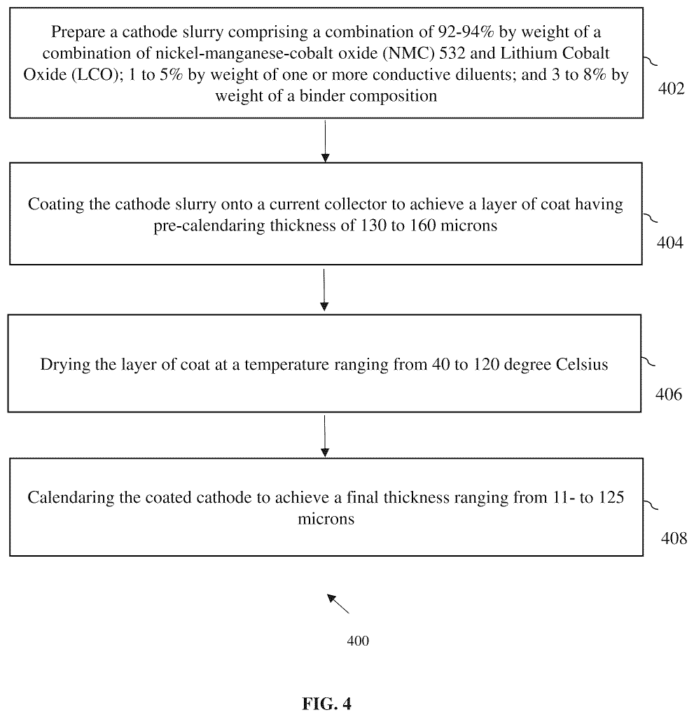

FIG. 4 is flowchart 400 illustrating a method of manufacturing a high power cathode for an electrochemical cell, according to an example embodiment.

At 402, a cathode slurry comprising a combination of 92-94% by weight of a combination of an electroactive material and an additive active material; 1 to 5% by weight of one or more conductive diluents selected from SWCNT (single walled carbon nanotubes), Super P, Multi-Walled Carbon Nanotubes (MWCNT), graphene, carbon nanofibers (CNFs), activated carbon, conducting carbon, porous carbon, and ketjen black; and 3 to 8% by weight of a binder composition.

In an embodiment, the electroactive material is selected from one or more of lithium manganese iron phosphate (LLMFP), lithium ferro phosphate (LFP), nickel-manganese-cobalt oxide (NMC) 111, NMC 532, NMC 622, NMC 811, NMC 9 0.5 0.5, Lithium Nickel Cobalt Aluminum Oxide (NCA), and the additive active material is selected from one or more of Lithium Cobalt Oxide (LCO), Lithium Nickel Cobalt Aluminum Oxide (NCA), and Lithium ion manganese oxide (LMO). In an example, the combination comprises 80 to 90% by weight of nickel-manganese-cobalt oxide (NMC) 532 and 20 to 10% by weight of Lithium Cobalt Oxide (LCO).

Further, the binder composition includes one or more binders selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate, is prepared. Typically, the one or more binders are mixed N-Methyl-2-pyrrolidone (NMP) solvent at a concentration of 45 to 55% by weight to form a uniform binder solution.

While making the cathode slurry, a solid content of the cathode slurry is adjusted to 45 to 55%, and a viscosity to 3000 to 6000 mPa·s, prior to coating the cathode slurry onto the current collector. In an embodiment, the viscosity of the slurry is controlled to 4500 millipascal-seconds (mPa·s). Maintaining this specific viscosity range is essential for achieving the desired flow characteristics of the slurry. A viscosity greater than 3000 mPa·s ensures that the slurry is adequately thick and cohesive, preventing segregation of the components during mixing or handling. At the same time, a maximum viscosity of 6000 mPa·s allows for ease of coating onto the conductive foil, ensuring uniformity in the application and adherence of the electrode layer.

The precise control of viscosity also influences the pore structure and distribution within the dried electrode, impacting its electrochemical performance. A well-balanced slurry viscosity is crucial for producing electrodes with optimal mechanical strength, conductivity, and porosity, thereby enhancing the overall efficiency and reliability of the resulting electrochemical cells.

At 404, the cathode slurry is coated onto a current collector to achieve a pre calendaring thickness of 130 to 160 microns. In an example, the current collector is made of aluminum and has a thickness ranging from 10 to 18 microns. In another example, the thickness of the current collector ranges from 10 to 12 microns. A thickness of a coat of the cathode slurry on the current collector ranges from 130 to 160 microns.

At 406, the coat is dried at a temperature ranging from 40 to 120 degree Celsius. Typically, a slow rate of heating ensures better adherence of the coat on the foil. Slow heating allows for water in the slurry to evaporate at a steady rate, preventing rapid drying, which could lead to cracks, delamination, or uneven coating due to localized stress. Moreover, the slower evaporation promotes better adhesion of the active material and binder mixture to the conductive foil by allowing the binders sufficient time to form strong chemical and physical bonds with both the active material and the conductive foil substrate.

This meticulous drying process also ensures a more homogeneous distribution of pores within the electrode, which is critical for optimizing ionic and electronic conductivity during battery operation. By controlling a drying temperature and rate, the process avoids thermal degradation of sensitive materials, such as binders, conductive additives, or the active material itself, preserving the electrode's structural and electrochemical integrity. Disclosed drying thus plays a pivotal role in achieving the desired electrode thickness, porosity, and mechanical robustness, all of which contribute to the overall performance and longevity of the electrochemical cell.

At 408, the coated cathode is calendared by applying pressure using rollers, to achieve a final thickness ranging from 110 to 125 microns. The process of calendaring involves passing the dried, coated electrode through a pair of rollers under controlled pressure. The objective is to compress the coated material to achieve a uniform thickness (typically 112 to 120 microns in this case) while retaining the desired porosity for efficient electrochemical performance. The calendaring of the coated cathode facilitates achieving a pore density ranging from 30 to 75%.

Further, the cathode is combined with a ceramic coated separator, an anode, an electrolyte, and is assembled into the electrochemical cell. A capacity of the electrochemical cell ranges up to 5 Ah. Further, a discharge rate exhibited by the electrochemical cell embodying the cathode is at least 25 C for pulse power, and is at least 11 C for continuous power, wherein the cathode continuously discharges at least at 45 Amperes.

This shows a great efficiency of the cell as it maintains a stable voltage over the majority of its capacity, delivering most of its charge with minimal voltage drop, which is a hallmark of high-performance energy storage.

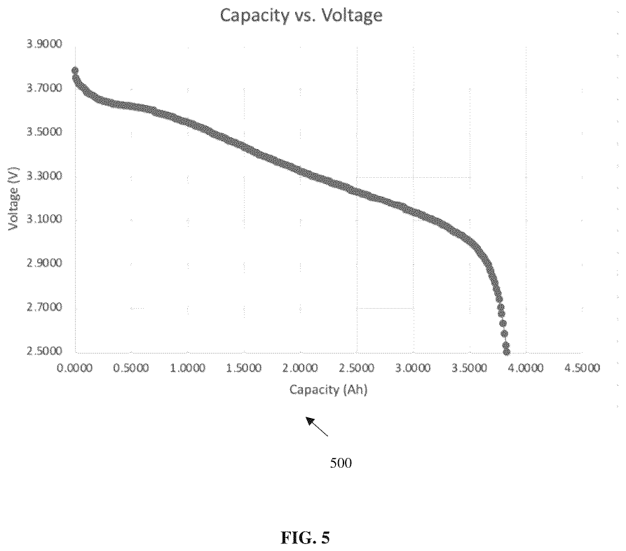

FIG. 5 illustrates a graph 500 depicting voltage as a function of the cathode's capacity during continuous discharge, in accordance with an example embodiment. The x-axis represents the capacity of the electrode, typically measured in ampere-hours (Ah), while the y-axis represents the voltage of the electrode, measured in volts (V).

The graph highlights the cell's discharge performance at a continuous rate of 11 C, showing a gradual voltage decrease from 3.8V to 2.5V as it delivers 3.85 Ah of capacity out of a total capacity of 4 Ah, which represents approximately up to 96.25% of its total 4 Ah capacity. This stable voltage profile across a significant portion of the electrode's capacity demonstrates the cell's efficiency and ability to provide consistent energy output, making it well-suited for applications that demand steady and reliable performance.

Subsequently, a sharper voltage drop occurs from 3.0V to 2.5V as the remaining 0.3 Ah of capacity is discharged. It is to be noted that the remaining 0.3 Ah is around 8% of the total capacity of the cell. This steep decline is typical of battery behavior as the remaining active material is exhausted. Importantly, the sharp drop occurs only near the end of the discharge cycle, maximizing usable capacity before performance deteriorates.

The cell effectively utilizes most of its charge (3.5 Ah out of 3.8 Ah) while maintaining high voltage levels, translating to reduced energy losses and efficient power delivery. The energy delivered is proportional to voltage×capacity, and the higher, stable voltage during the initial discharge ensures maximum energy extraction.

The graph illustrates the relationship between the battery's capacity and its voltage over its discharge cycle. The smooth curve shown here reflects consistent voltage stability across most of the discharge cycle, which is desirable for applications requiring reliable power output. Additionally, the sharp drop at the end indicates the cutoff voltage, helping users identify the usable range of the battery without over-discharging it, which could degrade performance or shorten the cell's lifespan. The graph demonstrates a low voltage drop, as the voltage remains stable throughout most of the discharge cycle, from 0 Ah to ˜3.5 Ah. This stability ensures consistent power delivery, which is crucial for high-power applications like power tools. The drop near the end (˜3.5 Ah to 3.85 Ah) indicates efficient energy utilization, with most of the capacity delivered at a stable voltage before reaching the cutoff point.

Batteries with such characteristics are ideal for applications requiring long runtimes, as they provide a stable power supply without frequent recharging or performance fluctuations. In summary, the ability of the cell to maintain a stable voltage (3.8V to 2.5V) while delivering 96.25% of its capacity at a discharge rate of 11 C, highlights its efficiency, reliability, and suitability for high-demand applications. The steep voltage drop only near the end ensures maximum utility of its capacity without premature performance degradation.

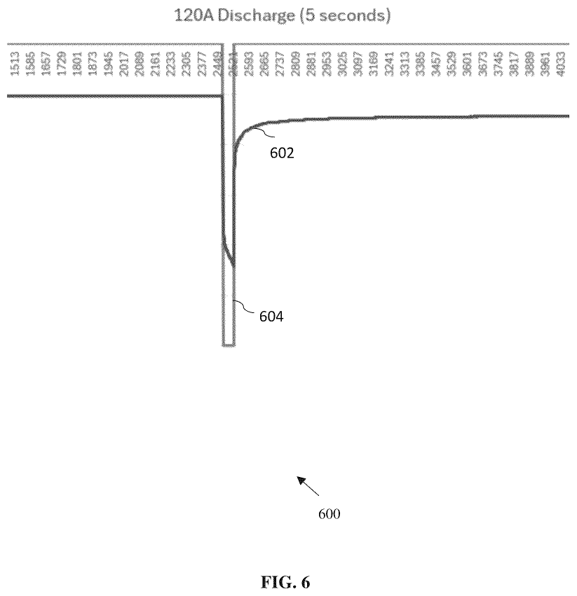

FIG. 6 is a graph 600 illustrating a pulse discharge of current and voltage of a cell, according to an example embodiment. The graph shows impact on the cell when 120 A current discharges in 5 seconds. The voltage drops to 3.6 volts and stabilizes back to 4.2 Volts (V), which is the original stable state of the cell. The graph highlights the voltage sag observed during a 120 A discharge, which is indicative of the battery's internal resistance. Despite the high discharge current, the voltage exhibits a smooth recovery back to 4.2V after the discharge, demonstrating the battery's stability and resilience, both of which are critical for consistent performance.

The ability of the battery to sustain such a high discharge current without significant long-term voltage instability underscores its strong rate capability and efficient energy delivery. The voltage drop to 3.6V during discharge and its subsequent stabilization near its original state show the battery's robust design and capacity to handle demanding conditions. This makes it suitable for applications requiring high power output without compromising the overall health and longevity of the battery.

For example, the dried electrode is fed into a calendaring machine equipped with precision rollers. The precision rollers are made of hard material like steel, tungsten carbide to provide uniform pressure of 20 MPa to 100 MPa. The pressure is adjusted to balance compression without causing structural damage or delamination of the coating from the foil. Further, the electrode is passed through the rollers at a controlled speed to ensure consistent compression. The duration of pressure application depends on the machine settings but is typically, in the range of milliseconds to a few seconds per pass. Multiple passes through the rollers are done to achieve the desired thickness and density of the coat. Incremental adjustments of 2 MPa in the pressure levels in each pass is done to ensure a uniform thickness of coat.

Due to the calendaring process, the overall porosity of the electrode is reduced, as the electroactive material is compressed to the binder. Pore reduction occurs during the calendaring process provides improved mechanical stability and electronic conductivity, as smaller pores with increased density improve an ionic conductivity and a surface area for electrolyte contact. The controlled calendaring process ensures that the cathode's pore structure supports high energy density, and power density. A specific energy density of the cathode obtained by disclosed method, is up to 205 Wh/Kg, and a power density is up to 5000 W/Kg. Further, the capacity of the electrochemical cell formed by using the disclosed cathode ranges from 3 Ah to 5 Ah.

The disclosed invention provides substantial advancements in the design and fabrication of high-performance electrodes for electrochemical cells, particularly for applications requiring high power densities. It incorporates an enhanced material composition, utilizing advanced conductive diluents like single-walled carbon nanotubes (SWCNTs), Super P, Super C65, and polyacrylic acid (PAA) to significantly improve electronic conductivity. Additives such as lithium tungsten oxide (LWO) and lithium titanium oxide (LTO) are included to enhance electrochemical performance and stability. The slurry formulation is meticulously optimized to achieve a controlled viscosity range of 3000 to 6000 mPa·s, ensuring a uniform distribution of active materials, binders, and conductive diluents. This uniformity minimizes segregation and ensures consistent coating on conductive foils, such as copper, leading to superior electrode reliability and performance.

The coating process is designed to uniformly apply a slurry layer with a thickness of 112-120 microns, resulting in a high-quality electrode with reduced defects and enhanced electrochemical and mechanical properties. A carefully executed drying protocol, maintained at temperatures between 40° C. and 120° C., prevents rapid evaporation, allowing better adherence of the coating to the conductive foil. This slow drying approach minimizes the risks of cracks, delamination, and uneven distribution while optimizing the electrode's porosity for improved ionic and electronic conductivity. Furthermore, the calendaring process employs controlled pressure, ranging from 20 MPa to 100 MPa, to compress the coated material into a uniform thickness while preserving the desired porosity. This balance ensures mechanical stability and porosity, leading to an electrode with enhanced energy density (up to 205 Wh/Kg) and power density (up to 5000 W/Kg).

The resulting electrode exhibits impressive electrochemical metrics, including a capacity of 4 Ah to 5 Ah, a discharge rate of at least 25 C for pulse power, and 11 C for continuous power. Such performance metrics make the electrode highly suitable for demanding applications, such as electric vehicles, air mobility systems, and power tools. Additionally, the disclosed methods and materials are scalable for large-scale production, ensuring consistency and quality. The choice of binders, diluents, and additives offers versatility in customizing the electrode for specific applications and performance requirements.

By addressing critical parameters such as material composition, viscosity control, drying techniques, and calendaring, this invention significantly enhances the efficiency, reliability, and longevity of electrochemical cells. It represents a valuable breakthrough in battery technology, offering scalable solutions for next-generation energy storage systems.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in a different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the example embodiments described are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

We claim:

1. A cathode for use in an electrochemical cell, comprising:
a composition coated on a current collector, the composition comprising:
85-95% by weight of a combination of an electroactive material and an additive active material;
3-8% by weight of one or more binders; and
1-5% by weight of one or more conductive diluents selected from single-walled carbon nanotubes (SWCNT), Super P, multi-walled carbon nanotubes (MWCNT), graphene, carbon nanofibers (CNFs), activated carbon, conducting carbon, porous carbon, and ketjen black.

2. The cathode of claim 1, wherein the electroactive material comprises one or more of lithium manganese iron phosphate (LLMFP), lithium ferro phosphate (LFP), nickel-manganese-cobalt oxide (NMC) 111, NMC 532, NMC 622, NMC 811, NMC 9 0.5 0.5, Lithium Nickel Cobalt Aluminum Oxide (NCA), and wherein the additive active material comprises one or more of Lithium Cobalt Oxide (LCO), Lithium Nickel Cobalt Aluminum Oxide (NCA), and Lithium ion manganese oxide (LMO).

3. The cathode of claim 1, wherein the combination comprises 80 to 90% by weight of nickel-manganese-cobalt oxide (NMC) 532 and 20 to 10% by weight of Lithium Cobalt Oxide (LCO).

4. The cathode of claim 3, wherein a particle size of NMC 532 is in a range of 4.0-8.0 micrometer, and wherein a density of NMC 532 is in a range of 3.4-3.8 g/cm³, and wherein a particle size of LCO is in a range of 10-15 micrometer, and wherein a density of LCO is in a range of 2.4-2.8 g/cm³.

5. The cathode of claim 1; wherein the one or more binders is selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate, and wherein the one or more binders are dissolved in a N-Methyl-2-pyrrolidone (NMP) solvent at a concentration of 45 to 55% by weight to create a uniform binder solution.

6. The cathode of claim 1, further comprising:
the current collector is made of aluminum and having a thickness ranging from 10 to 18 microns, and wherein the composition is coated on the current collector.

7. The cathode of claim 1, wherein the combination is a viscous slurry having viscosity of 3000-6000 millipascal-second (mPa·s), and wherein a solid content of the viscous slurry is in a range of 45-55%, and wherein a loading level of the combination is 15-35 mg/cm3, and wherein a thickness of a coat of the combination on the current collector ranges from 130 to 160 microns, and wherein the thickness of the coat is reduced to 110 to 125 microns by calendaring.

8. The cathode of claim 1, wherein the power density of the electrochemical cell exhibited is up to 5000 W/kg and the specific energy density is up to 205 Wh/kg, and wherein a capacity of the electrochemical cell ranges from 3 Ah to 5 Ah.

9. The cathode of claim 1, wherein the electrochemical cell comprising the cathode exhibits:
a discharge rate of at least 25 C for pulse power,
a discharge rate of at least 11 C for continuous power, wherein the cathode facilitates continuous discharge at a current of at least 45 Amperes, and wherein a capacity of the electrochemical cell is up to 5 Ah.

10. The cathode of claim 1, wherein the electrochemical cell comprising the cathode has a low internal resistance of 2.5 milliohms, and the low internal resistance facilitates a discharge of up to 96.25% of a capacity of the electrochemical cell capacity at a discharge rate of 11 C, when the electrochemical cell is discharged within an operational voltage range, and wherein the electrochemical cell comprising the cathode exhibits up to 300 charge-discharge cycles at a continuous discharge rate of 11 C and a pulse discharge rate of 25 C.

11. A method of manufacturing a high power cathode for an electrochemical cell, the method comprising:
preparing a cathode slurry comprising a combination of:
92-94% by weight of a combination of an electroactive material and an additive active material;
1 to 5% by weight of one or more conductive diluents selected from SWCNT (single walled carbon nanotubes), Super P, Multi-Walled Carbon Nanotubes (MWCNT), graphene, carbon nanofibers (CNFs), activated carbon, conducting carbon, porous carbon, and ketjen black; and
3 to 8% by weight of a binder composition comprising one or more binders selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate;
coating the cathode slurry onto a current collector to achieve a layer of coat having a pre-calendaring thickness of 130-160 microns;
drying the layer of coat of the cathode slurry at a temperature ranging from 40 to 120 degree Celsius; and
calendaring the coated cathode to achieve a final thickness ranging from 110 to 125 microns.

12. The method of claim 11, further comprising:
dissolving the one or more binders in a N-Methyl-2-pyrrolidone (NMP) solvent at a concentration of 45 to 55% by weight to form a uniform binder solution; and
adjusting a solid content of the cathode slurry to 45 to 55%, and a viscosity to 3000 to 6000 mPa·s, prior to coating the cathode slurry onto the current collector.

13. The method of claim 11, wherein the electroactive material comprises one or more of lithium manganese iron phosphate (LLMFP), lithium ferro phosphate (LFP), nickel-manganese-cobalt oxide (NMC) 111, NMC 532, NMC 622, NMC 811, NMC 9 0.5 0.5, Lithium Nickel Cobalt Aluminum Oxide (NCA), and wherein the additive active material comprises one or more of Lithium Cobalt Oxide (LCO), Lithium Nickel Cobalt Aluminum Oxide (NCA), and Lithium ion manganese oxide (LMO), and wherein the combination comprises 80 to 90% by weight of nickel-manganese-cobalt oxide (NMC) 532 and 20 to 10% by weight of Lithium Cobalt Oxide (LCO).

14. The method of claim 11, and wherein a loading level of the coat prior to the calendaring is maintained in a range of 15 to 35 mg/cm², wherein the calendaring of the coated cathode up to the final thickness facilitates achieving a pore density ranging from 30 to 75%.

15. The method of claim 11, further comprising:
combining the cathode with a ceramic coated separator, an anode and an electrolyte; and
assembling the cathode, the separator and the anode into the electrochemical cell.

16. The method of claim 11, wherein the electrochemical cell comprising the cathode exhibits:
a discharge rate of at least 25 C for pulse power,
a discharge rate of at least 11 C for continuous power, wherein the cathode facilitates continuous discharge at a current of at least 45 Amperes, and wherein a capacity of the electrochemical cell is up to 5 Ah.

17. An electrochemical device comprising:
a cathode comprising a combination of:
an electroactive material comprising a combination of NMC 532 and LCO in a range of 85-95% by weight;
one or more binders in a range of 3 to 8% by weight; and
one or more conductive diluents selected from SWCNT (single walled carbon nanotubes), Super P, Multi-Walled Carbon Nanotubes (MWCNT), graphene, carbon nanofibers (CNFs), activated carbon, conducting carbon, porous carbon, and ketjen black in a range of 1 to 5% by weight; wherein the combination is in a form of a slurry and is coated and dried on a positive current collector that is in electric connection with an external circuit;
an anode in electronic contact with a negative current collector that is in electric connection with the external circuit;
a separator positioned between the positive electrode and the negative electrode; and
an electrolyte in ionic contact with the positive and negative electrodes.

18. The electrochemical device of claim 17, wherein the positive current collector is made of aluminum and has a thickness ranging from 10 to 18 microns, wherein a thickness of the slurry coated on the positive current collector ranges from 130 to 160 microns, and wherein upon drying the slurry, the coated cathode is calendared to achieve a final thickness of 110 to 125 microns.

19. The electrochemical device of claim 17, wherein an internal resistance of the electrochemical device is 2.5 milliohms, resulting in a closed-circuit voltage of 3.8 volts when the open-circuit voltage is 4.2 volts, and wherein the electrochemical device exhibits a stable voltage profile during discharge, and wherein the stable voltage profile comprises a gradual voltage decrease from 3.80 V to 2.50 V under a continuous discharge rate of 11 C, while delivering a capacity of 3.85 Ah.

20. The electrochemical device of claim 17, wherein up to 96.25% of a capacity of the electrochemical device is available for discharge at a discharge rate of 11 C, when the cell is discharged within an operational voltage range.
